(19) United States
(12) Patent Application Publication
(10) Pub. No.: US 2008/0208662 A1
(43) Pub. Date: Aug. 28, 2008

(54) Goods information display system, method, and computer readable storage medium storing program thereof

(75) Inventors: Takeshi Asai, Osaka (JP); Yasushi Mishima, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/068,568

(22) Filed: Feb. 7, 2008

(30) Foreign Application Priority Data
Feb. 28, 2007 (JP) 2007-048415

(51) Int. Cl. G06Q 10/00; G06F 3/14

(52) U.S. Cl. 705/7

(57) ABSTRACT

Setting input unit 12 receives from a user an input concerning setting of conditions for selecting goods for topics of display, and registers the inputted setting information in a setting information storage 22. Goods selector 14 selects goods for topics of display on the basis of sales information recorded in a sales information storage 24 and the setting information stored in the setting information storage 22. Display share distributor 16 respectively distributes shares of display differently to the selected goods. Screen data output unit 18 configures screen data to be displayed on a display device 32 in accordance with distribution of the shares of display, and outputs the screen data to the display device 32.

### BACKGROUND OF THE INVENTION

1. Field of the Invention

The present invention relates to a system for displaying information of goods, and in particular, to a method for changing displayed contents in accordance with marketing situations of goods.

2. Description of the Related Art

In retail stores, etc., information of goods, such as “Today's Recommendations”, is displayed in order to encourage customers to buy the goods. Traditionally, information of goods was displayed on papers or blackboards. In recent years, electronic display using electronic media has also begun to be employed (see, for example, Japanese Unexamined Patent Application Publication No. 2002-372939).

However, the electronic display of the related art is only a replacement of display using electronic display media for display using paper or blackboards. Goods for topics of display, for example, are decided by persons. Accordingly, it is difficult to change the contents in accordance with a change in situation.

### SUMMARY

It is an object of the present invention to provide a goods information display method for selecting information of goods to be displayed and distributing shares of display to the selected goods.

According to a first aspect of the present invention, there is provided a goods information display system which displays information of goods on a display device. The goods information display system includes: a sales information storage which stores sales information of the goods, wherein the sales information indicates market situation of the goods, a screen data storage which stores screen data of the goods, a goods selector which calculates coefficients for the goods on the basis of corresponding sales information, and selects several goods from the goods on the basis of the coefficients, a display share distributor which distributes a share of display to each of the selected goods on the basis of the coefficients, and a screen data output unit which outputs the screen data of the selected goods on the display device in accordance with the distribution of the shares of display.

The display share distributor of the goods information display system may preferably distribute a dimension of a display screen of the display device. In such a configuration, the screen data output unit configures output data such that pieces of screen data of the selected goods are arranged within the display screen in accordance with the distribution of the dimension of the display screen.

The display share distributor of the goods information display system may preferably distribute display time. In such a configuration, the screen data output unit outputs pieces of the screen data of the selected goods in turn in accordance with the distribution of the display time.

The goods information display system may further include a setting input unit for receiving from a user an input of setting information which indicates a condition for selecting the several goods, wherein the goods selector calculates the coefficients for the goods on the basis of corresponding sales information and the setting information.

According to a second aspect of the present invention, there is provided a method which is executed by a goods information display system which displays information of goods on a display device. The goods information display system includes a sales information storage which stores sales information of the goods and a screen data storage which stores screen data of the goods, wherein the sales information indicates market situation of the goods. The method includes the steps of: calculating coefficients for the goods on the basis of corresponding sales information; selecting several goods from the goods on the basis of the coefficients; distributing a share of display to each of the selected goods on the basis of the coefficients; and outputting the screen data of the selected goods on the display device in accordance with the distribution of the shares of display.

According to a third aspect of the present invention, there is provided a computer readable storage medium which stores a program of instructions to a computer for executing a method of displaying information of goods on a display device. The computer includes a sales information storage which stores sales information of the goods and a screen data storage which stores screen data of the goods, wherein the sales information indicates market situation of the goods. The method includes the steps of calculating coefficients for the goods on the basis of corresponding sales information; selecting several goods from the goods on the basis of the coefficients; distributing a share of display to each of the selected goods on the basis of the coefficients; and outputting the screen data of the selected goods on the display device in accordance with the distribution of the shares of display.

According to the present invention, in accordance with a predetermined policy, depending on marketing situations of goods, a different display dimension and display time may be distributed to each of several selected goods for topics of display. Thus, a goods information display method for changing displayed contents in accordance with a change in situation can be provided.

### BRIEF DESCRIPTION OF THE DRAWINGS

FIG. 1 is a block diagram illustrating a system configuration of a goods information display system according to an embodiment of the present invention;

FIG. 2 is a diagram illustrating a flowchart of processes performed by a goods information display system according to an embodiment of the present invention;

FIG. 3 is a diagram illustrating an example of spatial distribution of shares of display;

FIG. 4 is a diagram illustrating an example of goods selection based on inventory amount of money;

FIG. 5 is a diagram illustrating an example of calculation of display coefficient based on graded classification;

FIG. 6 is a diagram illustrating an example of goods selection based on graded classification;

FIGS. 7A and 7B are diagrams illustrating examples of temporal distribution of shares of display;

FIG. 8 is a diagram illustrating an example of a combination of spatial distribution and temporal distribution of shares of display; and

FIG. 9 is a diagram illustrating an example of a computer environment.

### DESCRIPTION OF THE PREFERRED EMBODIMENTS

An embodiment of the present invention will be described below with reference to the accompanying drawings.

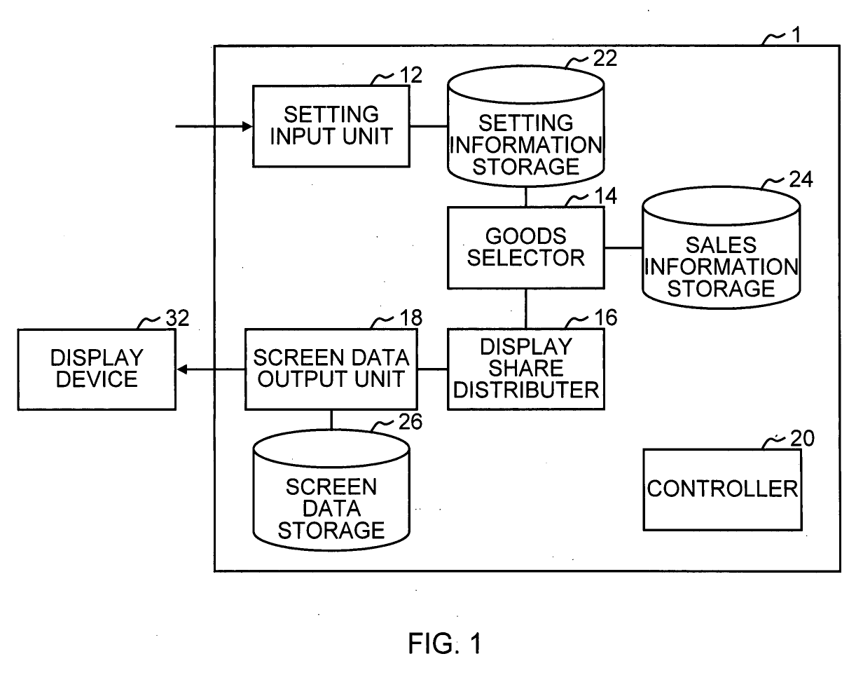

FIG. 1 is a block diagram illustrating a system configuration of a goods information display system according to an embodiment of the present invention. The goods information display system 1 includes a setting input unit 12 for receiving from a user an input of setting information of conditions for goods selection, a goods selector 14 for selecting goods for topics of display, a display share distributor 16 for distributing shares of display to the selected goods, a screen data output unit 18 for outputting screen data (for a display screen) to be displayed on a display device 32, a controller 20 for controlling the entirety of the goods information display system 1, a setting information storage 22 for storing the setting information inputted by the user, a sales information storage 24 for storing sales information of goods, and a screen data storage 26 for storing screen data to be displayed for each of the goods on the display device 32.

The setting input unit 12 receives from the user an input concerning setting of conditions for selecting goods for topics of display. The conditions may be defined in any form. In this embodiment, the conditions are defined as weighting for each of the goods. Alternatively, the processing may be implemented without setting conditions for simplicity.

The goods selector 14 selects goods for topics of display on the display device 32 on the basis of the sales information.

The display share distributor 16 distributes shares of display to the selected goods. Distribution of the shares of display includes two types, spatial distribution and temporal distribution. In the spatial distribution, by dividing the dimension of a display screen of the display device 32, the divided display dimensions are distributed to the selected goods. In the temporal distribution, screen data is displayed in turn on the display device 32 and a time length of display is distributed to the selected goods.

The screen data output unit 18 outputs screen data (for the display screen) to be displayed on the display device 32 on the basis of distribution of the shares of display. In the case of the spatial distribution, the screen data output unit 18 outputs to the display device 32 the screen data in a form in which pieces of screen data corresponding to the display dimensions distributed to the selected goods are arranged on the screen. In the case of the temporal distribution, after scheduling is performed in accordance with the times distributed to the selected goods, the screen data is updated in accordance with the schedule and is outputted to the display device 32.

The controller 20 controls the entirety of the goods information display system 1. Among processes performed in the goods information display system 1, processes other than those executed by the above means are all controlled by the controller 20.

The setting information storage 22 stores setting information inputted by the user.

The sales information storage 24 stores sales information including unit prices of goods, inventory information, sales records, etc. Information, such as the inventory information and the sales records, is separately updated by a POS (point of sale) system or the like. The updating of such information is not described here.

The screen data storage 26 stores screen data to be displayed on the display device 32 for each of the goods. Different types of screen data are prepared for the goods so as to correspond to distributed display dimensions. As the size of the distributed display dimension increases, more information may be prepared for display, or enlarged data of the same screen data may be prepared for display. Instead of preparing different types of screen data so as to correspond to different sizes of display dimensions, one type of screen data may be prepared and may be displayed in an enlarged manner or reduced manner in accordance with the display dimension.

Processes performed by the goods information display system 1 will be described below.

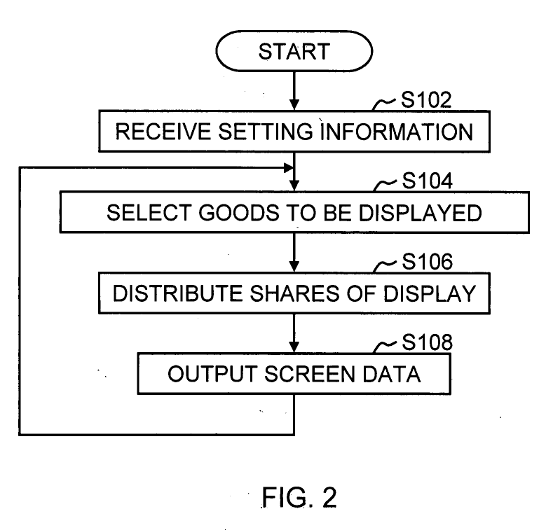

FIG. 2 is a diagram illustrating a flowchart of processes performed by a goods information display system according to an embodiment of the present invention. The flow of the processes of the goods information display system 1 will be sequentially described in order from step S102 to step S108 shown in FIG. 2.

In step S102, the setting input unit. 12 receives, from the user, input of setting information concerning conditions for selecting several goods for topics of display, and registers the inputted setting information in the setting information storage 22.

In step S104, the goods selector 14 selects goods for topics of display on the basis of the sales information stored in the sales information storage 24 and the setting information stored in the setting information storage 22. Goods selection is performed every predetermined time period. The goods selection may be performed whenever the sales information is updated. The goods selection may be performed when a particular condition is satisfied (for example, in the case when the inventory quantity of particular goods is equal to or less than a predetermined quantity). In selecting goods, sales information of each of the goods is digitized and converted into a display coefficient by weighting on the basis of the setting information stored in the setting information storage 22. The goods selector 14 ranks the goods on the basis of the display coefficients, and selects a predetermined number of goods from higher ranked goods. Alternatively, goods that satisfy a predetermined condition may be selected instead of selecting the predetermined number of goods.

In step S106, the display share distributor 16 differently distributes shares of display to each of the selected goods. In the distribution of the shares of display, a display dimension or display time may be distributed in proportion to a display coefficient, or several predetermined display dimensions or display times may be distributed in the order of the display coefficients.

In step S108, the screen data output unit 18 configures screen data to be displayed on the display device 32 on the basis of distribution of the shares of display, and outputs the screen data to the display device 32. In the case of the spatial distribution, the screen data output unit 18 configures screen data by arranging pieces of screen data of the selected goods in accordance with predetermined screen arrangement, and outputs the screen data to the display device 32. In the case of the temporal distribution, after a display schedule is established in accordance with distribution of display times, screen data is updated so that pieces of screen data of the selected goods are displayed in turn, and the screen data is outputted to the display device 32.

By employing the above-described configuration, in accordance with a predetermined policy, display dimensions and display times may be distributed in accordance with marketing situations of each of the selected goods.

The embodiment of the present invention is described below by using a specific example.

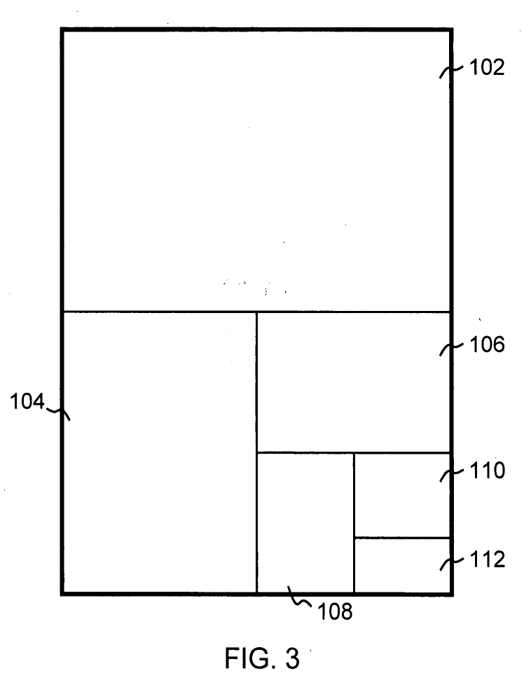

FIG. 3 is a diagram illustrating an example of spatial distribution of shares of display. In FIG. 3, the thick frame indicates the display screen, and the divided regions inside the thick frame represent display regions respectively distributed to the selected goods. In the example shown in FIG. 3, pieces of information of six goods having larger display coefficients are distributed in order of the dimension of the display regions.

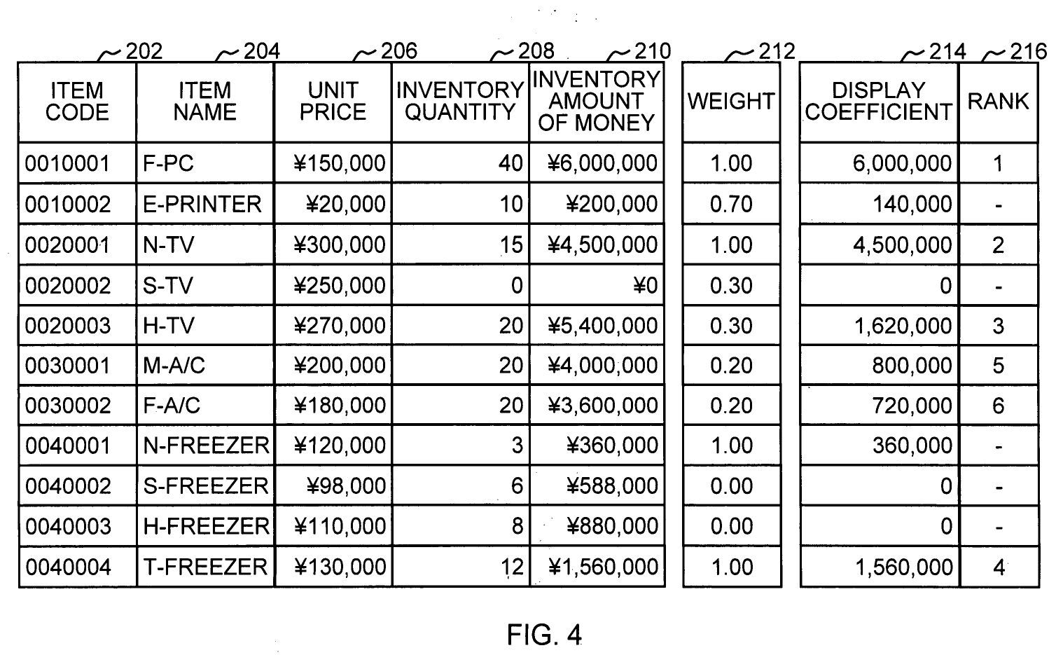

FIG. 4 is a diagram illustrating an example of goods selection based on inventory amount of money. In the example shown in FIG. 4, goods for topics of display are selected on the basis of inventory amount of money (“unit price”×“inventory quantity”) of goods. Item Code 202 to Inventory Amount of Money 210 indicates respectively information obtained from the sales information stored in the sales information storage 24. Weight 212 indicates information obtained from the setting information stored in the setting information storage 22. Display Coefficient 214 indicates a value calculated by multiplying the Inventory Amount of Money 210 by the Weight 212. Rank 216 indicates the ranks of the top six most highly ranked Display Coefficient 214 in the order of magnitude. Pieces of information of the goods having Rank 216 of one of ranks 1 to 6 are arranged in accordance with the Rank 216 in turn from the largest display region in FIG. 3, whereby screen data is configured. The shares of display may be distributed by regarding the Inventory Amount of Money 210 or Inventory Quantity 208 themselves as the Display Coefficient 214 without setting the Weight 212. By displaying information of goods in the above manner, sales promotion of goods whose inventory amount of money is too large may be achieved. Setting the Weight 212 enables adjustment so that information of particular goods can be preferentially displayed. As described above, by preferentially displaying information of goods of a particular manufacturer or particular category, sales promotion based on preferences of dealers can be achieved. The Display Coefficient 214 may be calculated on the basis of the Inventory Quantity 208 instead of the Inventory Amount of Money 210. Alternatively, the Display Coefficient 214 may be calculated on the basis of sales quantity or gross sales price for sold goods. By displaying information of goods in this manner, further sales promotion of goods in great demand can be achieved. In this case, such goods whose inventory quantities are zero may not be selected. Goods for topics of display may be selected from such goods whose sales quantity or gross sales price is lower. By displaying information of goods in this manner, sales promotion of goods having poor sales can be achieved.

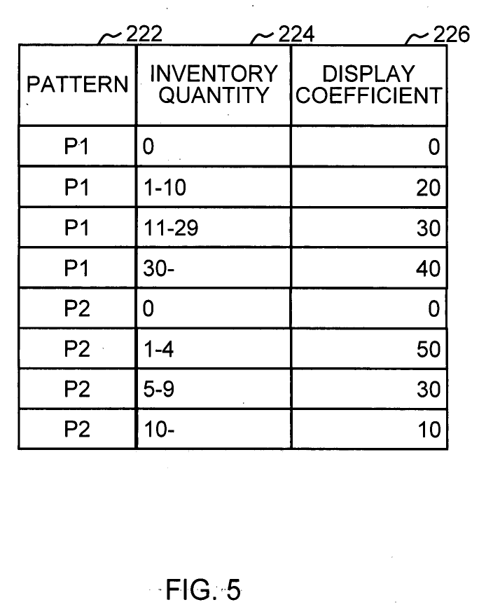

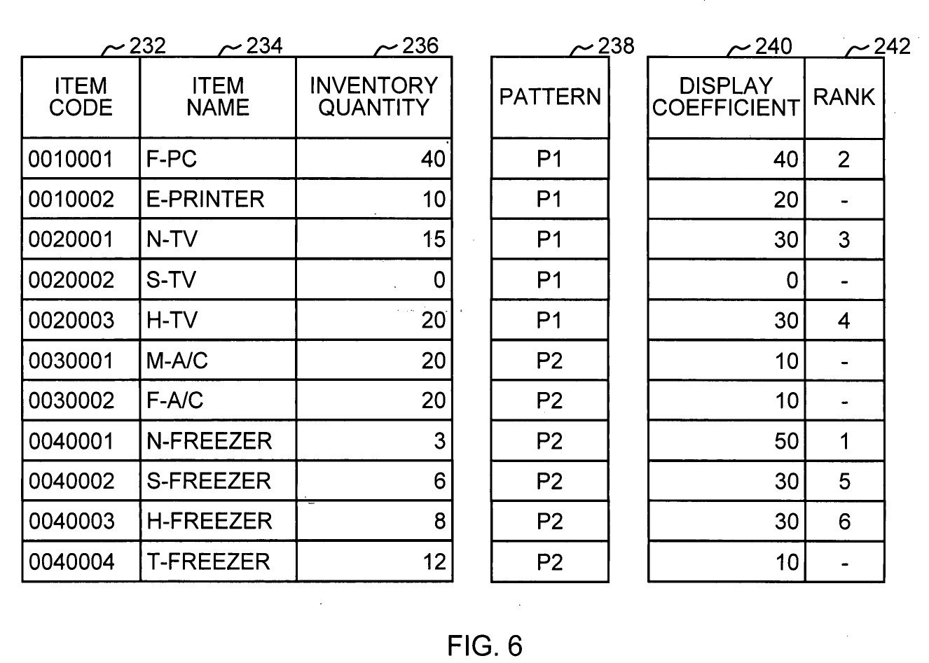

Alternatively, the display coefficients may be derived by classifying inventory quantity, inventory amount of money, sales quantity, or gross sales price of the goods in grades. FIG. 5 is a diagram illustrating an example of calculation of display coefficient based on graded classification. A pattern P1 is a pattern for promoting goods whose inventory quantity is large. The pattern P1 is defined so that the greater Inventory Quantity 224, the greater Display Coefficient 226. A pattern P2 is a pattern for selling out goods whose inventory quantity is small. The pattern P2 is defined so that, when Inventory Quantity 224 is small, Display Coefficient 226 is extremely large. The pattern definition information is set by the user and is stored in the setting information storage 22. FIG. 6 is a diagram illustrating an example of goods selection based on graded classification. In the example shown in FIG. 6, several goods for topics of display are selected on the basis of Inventory Quantity 236. Item Code 232 to Inventory Quantity 236 indicates respectively information obtained from the sales information stored in the sales information storage 24. Pattern 238 indicates information obtained from the setting information stored in the setting information storage 22. Display Coefficient 240 indicates a value calculated from Inventory Quantity 236 and the Pattern 238 on the basis of the pattern definition information shown in FIG. 5. Rank 242 indicates ranks of the six highest Display Coefficient 240. By displaying information of goods in this manner, on the basis of the sales information, more flexible ways of sales promotion may be achieved.

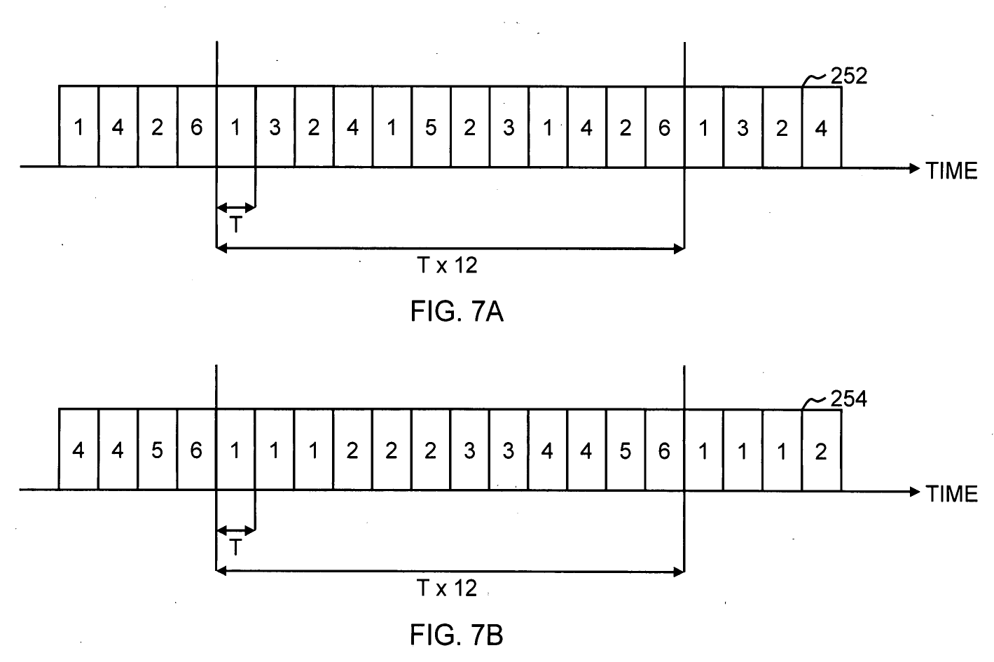

FIGS. 7A and 7B are diagrams illustrating examples of temporal distribution of shares of display. In FIGS. 7A and 7B, the letter T denotes a predetermined unit time. For example, T=15 seconds. In other words, information of goods is displayed in units of 15 seconds. In the examples shown in FIGS. 7A and 7B, information display of six goods is repeated in a cycle of 12 time units. Six time frames, that is, frame numbers 1 to 6, are prepared. Three time units are assigned to each of frame numbers 1 and 2, two time units are assigned to each of frame numbers 3 and 4, and one time unit is assigned to each of frame numbers 5 and 6. Six goods having greater display coefficients are distributed to frame numbers 1 to 6 in order and pieces of information of the goods are displayed in distributed time frames. FIGS. 7A and 7B respectively show arrangements 252 and 254 as examples of a time-frame arrangement. In the arrangement 252, the information of the goods is changed unit by unit. Pieces of information of the goods distributed to frame numbers 1 and 2 are frequently displayed in a short cycle (4-unit cycle), and pieces of information of the goods distributed to frame numbers 5 and 6 are displayed in a long cycle (12-unit cycle). In the arrangement 254, the cycles of display of screen data are equal (12-unit cycle), and the pieces of information of the goods are displayed in succession during a time period corresponding to the number of time units assigned to the time frame distributed to each of the selected goods.

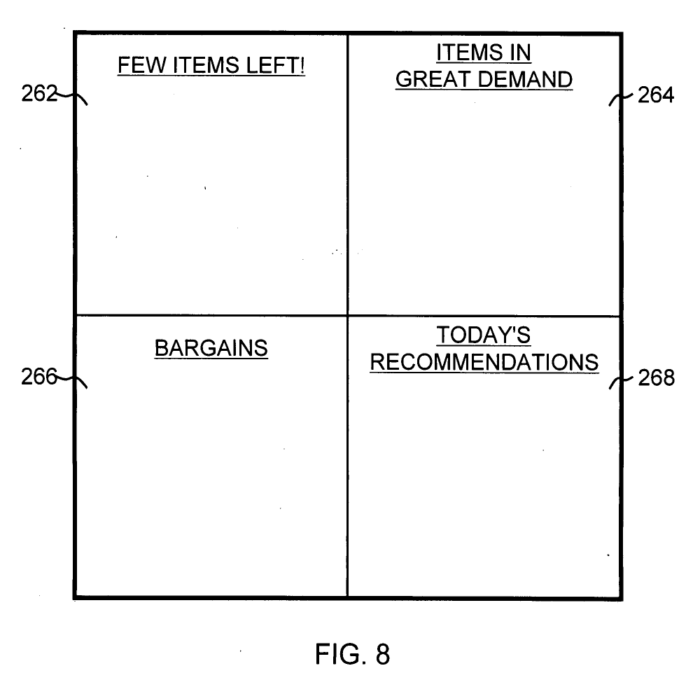

FIG. 8 is a diagram illustrating an example of a combination of spatial distribution and temporal distribution of shares of display. In the example shown in FIG. 8, the screen is divided into four display regions, and different meanings (specifically, “Few Items Left!”, “Items in Great Demand”, “Bargains”, and “Today's Recommendations”) are given to the display regions 262-268, respectively. For each display region, one of the goods is selected on the basis of a goods selection policy and setting information corresponding to the meaning given to the region, and, for the selected goods, temporal distribution is performed in each display region. Although, in FIG. 8, the four display regions have equal dimensions, the display dimensions may be changed, and the meanings of the display regions may be switched in accordance with the marketing situations.

In the spatial distribution, in addition to determining priorities of the display regions on the basis of their dimensions, for example, determination of the priorities on the basis of display positions on the screen may be employed such as, for example, prioritizing an upper portion of the screen, or prioritizing a central portion of the screen.

In addition, identical goods may have different colors. In a case in which goods images are displayed as screen data, when the number of in-stock goods of the displayed color is zero, an image of the in-stock goods may be switched to an image of in-stock identical goods of a different color.

As described above, according to the present invention, in accordance with a predetermined policy, display dimensions and display times can be distributed depending on marketing situations of the goods. Thus, a goods information display method for changing displayed contents in accordance with a change in situation can be provided.

The functions of the above-described goods information display system 1 according to the embodiments of the present invention can be realized not only by hardware but also by computer software. For example, by creating a program for allowing a computer to execute the functions of the setting input unit 12, goods selector 14, display share distributor 16, screen data output unit 18, and controller 20 shown in FIG. 1, and loading the program into a memory of the computer, the functions of the goods information display system 1 can be realized.

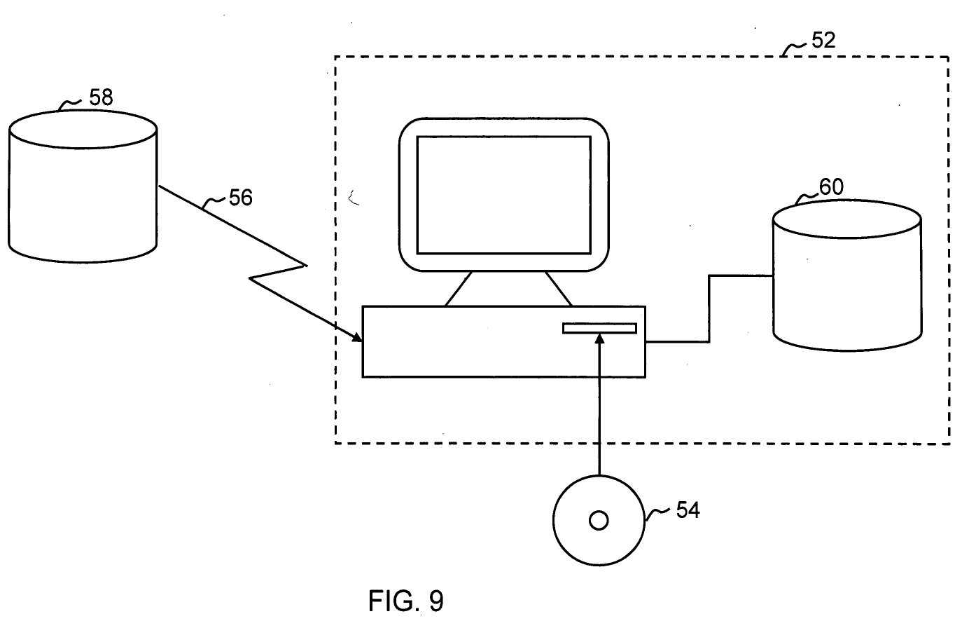

As shown in FIG. 9, the program realizing the goods information display system 1 according to the embodiments of the present invention may be stored not only in a portable recording medium 54 such as a CD-ROM (compact-disc read-only memory), CD-RW (compact disc rewritable), DVD-R (digital versatile disc recordable), DVD-RAM (digital-versatile-disc random access memory), or flexible disk, but also in one of another storage device 58 provided at an end of a communication line 56, a storage device such as a hard disk drive or RAM in a computer system 52, and a recording medium 60. When being executed, the above program is loaded and executed in a main memory.

What is claimed is:

1. A goods information display system for displaying information of goods on a display device, comprising:
a sales information storage for storing sales information of the goods, the sales information indicating market situation of the goods;
a screen data storage for storing screen data of the goods;
a goods selector for
calculating coefficients for the goods on the basis of corresponding sales information, and
selecting several goods from the goods on the basis of the coefficients;
a display share distributor for distributing a share of display to each of the selected goods on the basis of the coefficients; and
a screen data output unit for outputting the screen data of the selected goods on the display device in accordance with the distribution of the shares of display.

2. The goods information display system of claim 1, wherein
the display share distributor distributes a dimension of a display screen of the display device, and
the screen data output unit configures output data such that pieces of screen data of the selected goods are arranged within the display screen in accordance with the distribution of the dimension of the display screen.

3. The goods information display system of claim 1, wherein
the display share distributor distributes display time, and
the screen data output unit outputs pieces of the screen data of the selected goods in turn in accordance with the distribution of the display time.

4. The goods information display system of claim 1, further comprising:
a setting input unit for receiving from a user an input of setting information indicating a condition for selecting the several goods, wherein
the goods selector calculates the coefficients for the goods on the basis of corresponding sales information and the setting information.

5. A method executed by a goods information display system for displaying information of goods on a display device, the goods information display system including a sales information storage for storing sales information of the goods and a screen data storage for storing screen data of the goods, the sales information indicating market situation of the goods, the method comprising the steps of:
calculating coefficients for the goods on the basis of corresponding sales information;
selecting several goods from the goods on the basis of the coefficients;
distributing a share of display to each of the selected goods on the basis of the coefficients; and
outputting the screen data of the selected goods on the display device in accordance with the distribution of the shares of display.

6. The method of claim 5, wherein
a dimension of a display screen of the display device is distributed in the step of distributing a share of display, and
output data is configured such that pieces of screen data of the selected goods are arranged within the display screen in accordance with the distribution of the dimension of the display screen in the step of outputting the screen data.

7. The method of claim 5, wherein
display time is distributed in the step of distributing a share of display, and
pieces of the screen data of the selected goods are outputted in turn in accordance with the distribution of the display time in the step of outputting the screen data.

8. The method of claim 5, further comprising the step of:
receiving from a user an input of setting information indicating a condition for selecting the several goods, wherein
the coefficients for the goods are calculated on the basis of corresponding sales information and the setting information in the step of calculating coefficients.

9. A computer readable storage medium storing a program of instructions to a computer for executing a method of displaying information of goods on a display device, the computer including a sales information storage for storing sales information of the goods and a screen data storage for storing screen data of the goods, the sales information indicating market situation of the goods, the method comprising the steps of:
calculating coefficients for the goods on the basis of corresponding sales information;
selecting several goods from the goods on the basis of the coefficients;
distributing a share of display to each of the selected goods on the basis of the coefficients; and
outputting the screen data of the selected goods on the display device in accordance with the distribution of the shares of display.

10. The computer readable storage medium of claim 9, wherein
a dimension of a display screen of the display device is distributed in the step of distributing a share of display, and
output data is configured such that pieces of screen data of the selected goods are arranged within the display screen in accordance with the distribution of the dimension of the display screen in the step of outputting the screen data.

11. The computer readable storage medium of claim 9, wherein
display time is distributed in the step of distributing a share of display, and
pieces of the screen data of the selected goods are outputted in turn in accordance with the distribution of the display time in the step of outputting the screen data.

12. The computer readable storage medium of claim 9, the method further comprising the step of:
receiving from a user an input of setting information indicating a condition for selecting the several goods, wherein
the coefficients for the goods are calculated on the basis of corresponding sales information and the setting information in the step of calculating coefficients.
